(19) United States
(12) Patent Application Publication
(10) Pub. No.: US 2010/0141847 A1
(43) Pub. Date: Jun. 10, 2010

(54) Mobile television device with break-resistant integrated telescoping antenna

(76) Inventors: Subramanian Jayaram, Austin, TX (US); James W. Clardy, Austin, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/315,801

(22) Filed: Dec. 5, 2008

(51) Int. Cl. H04N 5/455

(52) U.S. Cl. 348/726; 348/E05.113

(57) ABSTRACT

Systems and methods are disclosed for mobile television (TV) devices including collapsible antenna structures that are resistant to breaking. The antenna structure allows for a highly mobile antenna/receiver module that can be attached to a standard computer system through a standardized bus interface, such as a USB (universal serial bus) interface. The collapsible antenna is configured to retract into the body of the mobile TV device, as well as to telescope out and articulate (bend) in any direction. The antenna includes strain relief techniques to avoid breakage, for example, a flexible base telescoping segment. The mobile TV device can also include a printed circuit board including an RF (radio frequency) front-end with a tuner, a digital signal demodulator and decoder and a digital bus interface in a single, highly integrated device.

### TECHNICAL FIELD

The techniques described herein relate to mobile television (TV) devices and, more particularly, to mobile TV devices capable of operating in multiple different broadcast standards.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems are being configured to receive digital television broadcasts. Larger information handling systems can have television (TV) tuner and demodulator circuitry included within the system itself. Smaller and portable information handling systems, however, often do not have internal space to house this TV reception related circuitry. To address this problem, portable television (TV) devices have been made for information handling systems and, more particularly, for small, mobile systems. Some prior portable TV solutions have provided USB (universal serial bus) attached TV tuners to provide mobile TV reception. The demodulation is then performed through software running on the information handling system. In addition, some prior devices have used retractable, pull-out antennas. These prior solutions, however, do not provide efficient, easy to use and cost effective solutions, particularly for portable TV devices capable of receiving multi-standard broadcasts in different geographic regions.

### SUMMARY

Systems and methods are disclosed for mobile television (TV) devices including collapsible antenna structures that are resistant to breaking. The antenna structure allows for a highly mobile antenna/receiver module that can be attached to a standard computer system through a standardized bus interface, such as a USB (universal serial bus) interface. The mobile TV device product is easy to use and highly portable. The collapsible antenna is configured to retract into the body of the mobile TV device, as well as to telescope out and articulate (bend) in any direction. The antenna includes strain relief techniques to avoid breakage, for example, a flexible base telescoping segment. The mobile TV device can also include a printed circuit board including an RF (radio frequency) front-end with a tuner, a digital signal demodulator and decoder and a digital bus interface in a single, highly integrated device. As described below, other features and variations can be implemented, as desired, and a related methods and systems can be utilized, as well.

### DESCRIPTION OF THE DRAWINGS

It is noted that the appended drawings illustrate only example embodiments of the techniques described herein and are, therefore, not to be considered limiting of its scope, for the invention may admit to other equally effective embodiments.

FIG. 1 is a block diagram for a mobile television (TV) device having a collapsible antenna as described herein.

FIG. 2 is a diagram for a mobile television (TV) device with a collapsible antenna extended.

FIG. 3A is a diagram for a collapsible antenna in its extended position.

FIG. 3B is diagram for a collapsible antenna in its collapsed position.

FIG. 4A is a side-view diagram for a connection mechanism for a collapsible antenna.

FIG. 4B is a top-view diagram for a connection mechanism for a collapsible antenna.

FIG. 5A is an exploded view for a mobile television (TV) device having a collapsible antenna and a connection mechanism.

FIG. 5B is a diagram for an internal connection sleeve for the antenna connection mechanism.

### DETAILED DESCRIPTION OF THE INVENTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a server computer system, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

As described herein, systems and methods provide mobile television (TV) devices including collapsible antenna structures that are resistant to breaking. This antenna structure allows for a highly mobile antenna/receiver module that can be attached to a standard computer system through a standardized bus interface and bus interface connector, such as a USB (universal serial bus) interface and a USB connector. The mobile TV device product is easy to use and highly portable. An antenna is provided that is capable of retracting into the body of the mobile TV device, as well as telescoping out and articulating (bending) in any direction. The antenna includes strain relief techniques to avoid breakage. The mobile TV device can also include a printed circuit board including an RF front-end with a tuner, a digital signal demodulator and decoder and a digital bus interface in a single, highly integrated device.

Advantageously, due to the configurability of the antenna and the internal tuner/demodulator circuitry, the mobile TV device described herein can support a wide variety of digital video broadcast standards, such as DVB-T, CMMB, T-DMB, ISDB-T, DAB and ATSC broadcast TV and radio standards. The mobile TV device can also include a USB 2.0 form factor attached dongle with software support for LINUX, WINDOWS XP and WINDOWS VISTA and/or some other desired operation system.

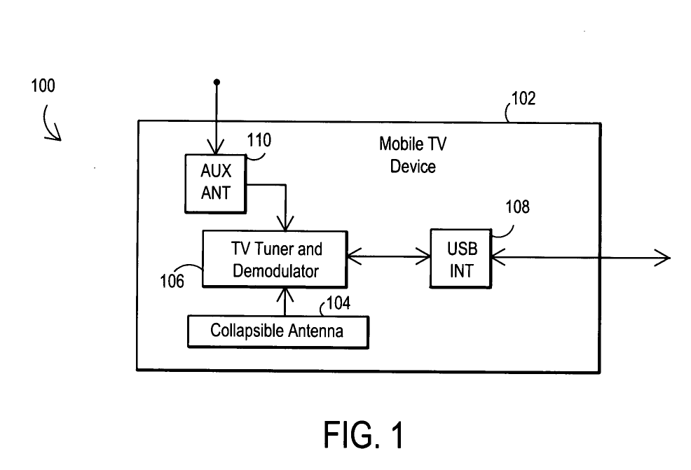

FIG. 1 is a block diagram for a mobile television (TV) device 100 having a collapsible antenna 104 as described herein. As depicted, the mobile TV device 100 includes a device body 102 within which is housed a collapsible antenna 104. In addition, the mobile TV device 100 further includes TV tuner and demodulator circuitry 106. The TV tuner and demodulator circuitry 106 operates to receive, tune and demodulate radio frequency (RF) television broadcast signals received from the collapsible antenna 104. The TV tuner and demodulator circuitry 106 can also receive television broadcast signals through an external antenna, if one is connected to the auxiliary antenna (AUX ANT) input 110. The TV tuner and demodulator circuitry 106 provides TV output signals for received content that can be communicated to external devices, for example, through a USB (universal serial bus) interface (INT) 108. In other words, the USB interface can be used to communicate demodulated television broadcast information to an external device. Other wired or wireless interfaces could also be utilized, if desired, to communication this information.

It is noted that the TV tuner and demodulator circuitry 106 can be implemented with one or more integrated circuits, but is preferably implemented with a single integrated circuit. It is further noted that the TV tuner and demodulator circuitry 106 is preferably a multi-standard tuner/demodulator such that it can receive, tune and demodulate TV broadcast channels broadcast using different standards, such digital TV broadcasts in different geographic regions of the world. This desired multi-standard operation of the mobile TV device 100 means that it is also desirable for the antenna 104 to be configurable for a plurality of different reception frequencies. The collapsible nature of the collapsible antenna 104, as described further below, allows for this antenna to be adjusted by a user for optimal reception. In effect, by adjusting the length of the collapsible antenna 104, the user is able to configure the antenna for better reception of different broadcast frequencies.

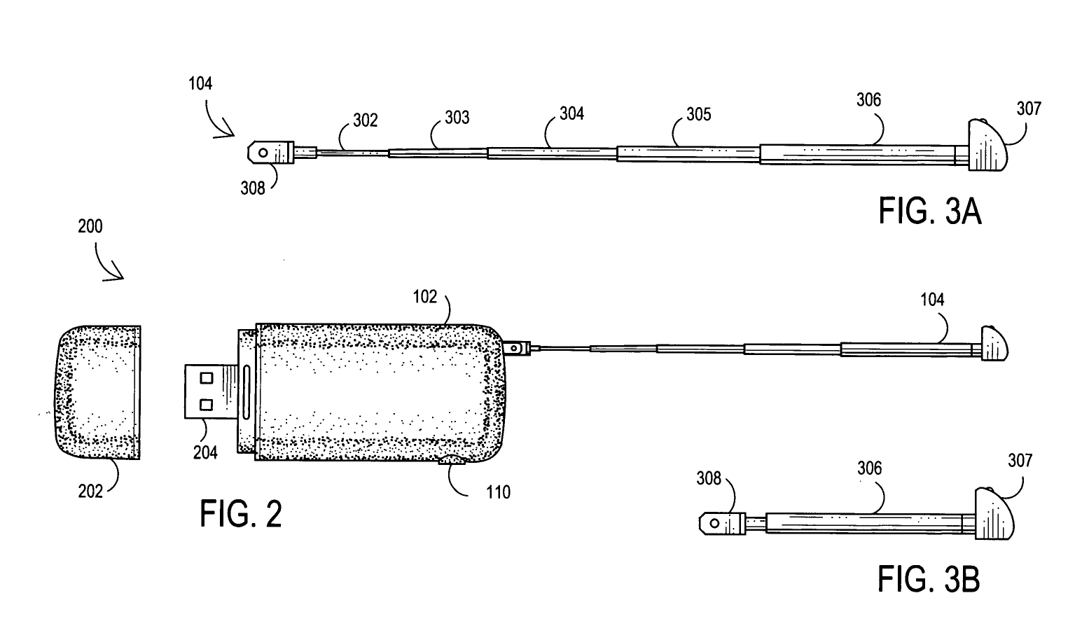

FIG. 2 is a diagram for an embodiment 200 for a mobile television (TV) device with a collapsible antenna 104 in its extended position. As depicted, the mobile TV device has a device body 102 with a releasable cap 202. The releasable cap covers a USB connector 204. The mobile TV device further has an auxiliary antenna connection 110 for receiving a connection to an external antenna. The collapsible antenna 104 has an advantageous reverse telescoping configuration and is connected to the device body 102 using an advantageous antenna connection mechanism, as described in more detail below. It is further noted that the mobile TV device described herein allows for a small, compact and highly portable design. For example, the length of the device can be 77 millimeters, the width can be 30 millimeters, and the height can be 12.8 millimeters.

FIG. 3A is a diagram for an embodiment for a collapsible antenna 104 in its extended position. As depicted, the antenna 104 has a plurality of telescoping segments, such as the five segments shown. A cap 307 is connected to the end of segment 306 and forms the distal end of the antenna. It is noted, though, that more segments or fewer segments could be used, as desired. Unlike typical antenna structures, however, the largest segment is the segment 306 adjacent the end of the antenna. Segment 305 is next to segment 306 and configured to telescope inside of segment 306. Segment 304 is next to segment 305 and configured to telescope inside of segment 305. Segment 303 is next to segment 304 and configured to telescope inside of segment 304. And segment 302 is next to segment 303 and configured to telescope inside of segment 303. Segment 302 is also connected to the connector 308, which is used to connect the antenna to an internal retaining structure within the mobile TV device. The connector 308 has a pin hole through which a pin is placed to secure the connector 308 to the mobile TV device, as discussed in more detail below.

Significantly, to allow the antenna to be resistant to breaking, the base segment 302 is made to be flexible. For example, the base segment 302 can be made from a flexible metal material. The segment is also rigidly connected to the connector 308. When the antenna 104 is extended, the connector 308 and the segment 302 will be positioned outside the mobile TV device. When pressure is place on the antenna, the flexible segment 302 will bend thereby allowing the antenna to resistant breaking.

In operation of the mobile TV device, the user can adjust the length of the antenna by adjusting the telescoping segments until the reception is optimal. In addition, as described above, different broadcast frequencies are received better by different antenna lengths. The adjustable length of antenna 104, therefore, allows for reception of these different broadcast frequencies, such as broadcasts using multiple different standards in a wide range of geographic regions. If desired, the antenna 104 can be sized so that it will operate as a quarter wave antenna for the broadcast frequencies it is expected to receive. When completely collapsed, for example, the collapsible antenna can be configured and sized so as to be a quarter wave antenna that effectively receives UHF television signals (i.e., signals in a frequency range of about 70 MHz to 1002 MHz). In one embodiment, with the dimensions indicated above for the mobile TV device (e.g., 77 mm×30 mm×12.8 mm), the antenna can be 105 millimeters in length when fully extended, and the antenna can be 38 millimeters in length when fully collapsed. It is further noted that the effective length of the antenna 104 is further extended by the connection mechanisms used to connect the antenna 104 to the mobile TV device.

FIG. 3B is diagram for a collapsible antenna 104 in its collapsed position. As depicted, the antenna 104 has been collapsed down into its shortest configuration. As such, only the largest segment 306 is still visible, as is the cap 307. The connector 308, which connects to the flexible segment 302 is also visible. Even in this configuration, should a force be applied to the antenna, the flexible segment 302, although not visible, will still tend to bend thereby allowing the antenna to resist breaking.

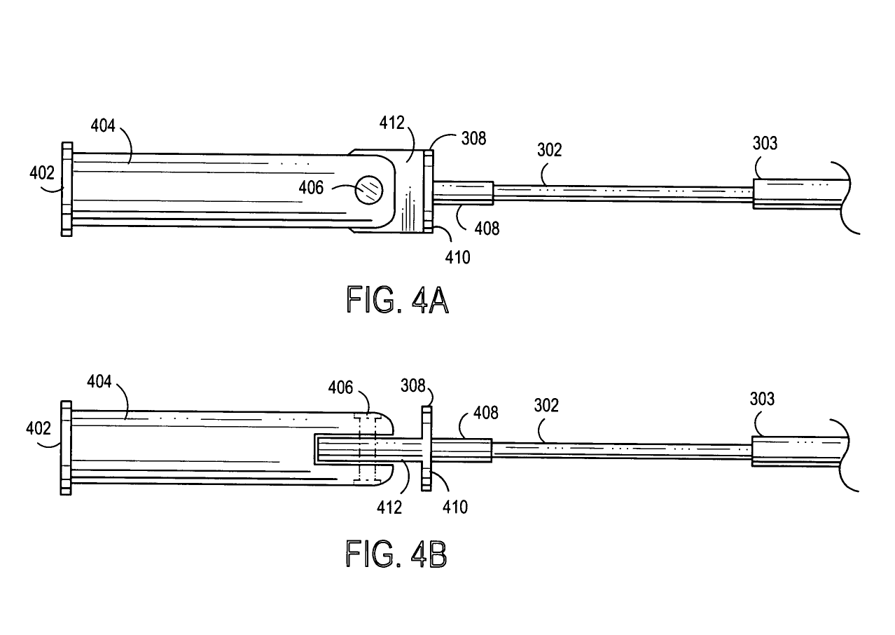

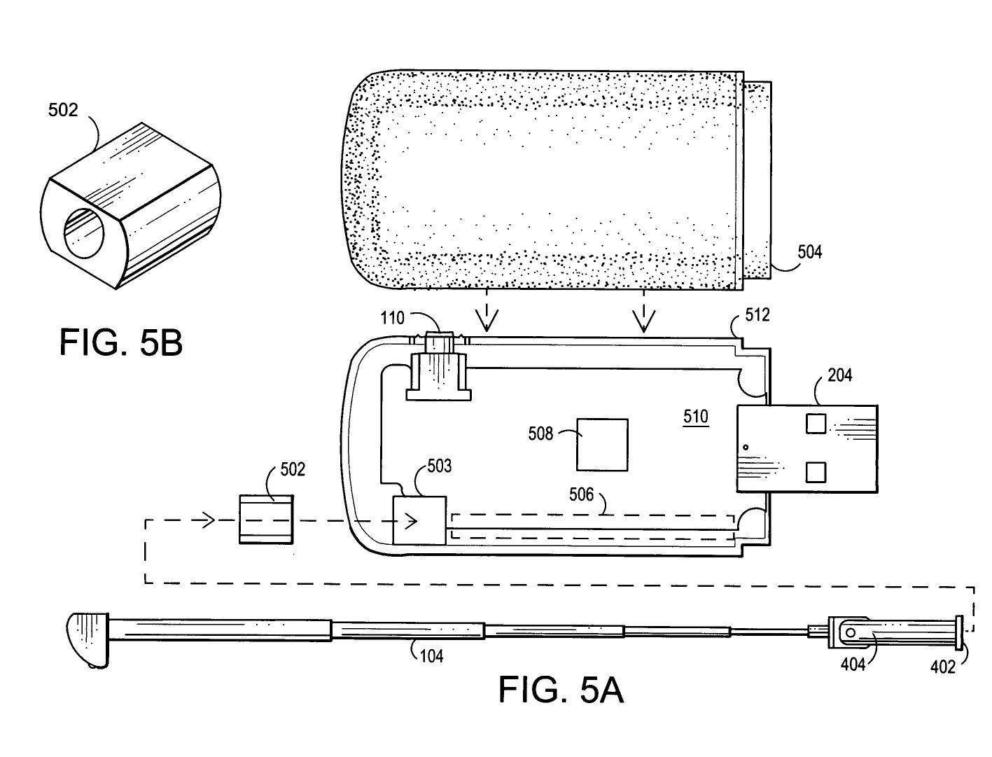

FIG. 4A is a side-view diagram for an antenna connection mechanism for the collapsible antenna 104. As depicted, the connector 308 for the antenna 104 has a housel 408 that receives the base segment 302. This housel 408 is in turn connected to a base 410 that includes a flat section 412 that is inserted into the end of a retaining cylinder 404. A pin 406 is then placed through the pin hole in connector 308 to secure connector 308 to the retaining cylinder 404 and to allow the connector 308 to rotate in one plane, as shown more clearly with respect to FIG. 4B. The retaining cylinder 404 also includes a cap ring 402 that is slightly larger in diameter than the retaining cylinder 404. As described with respect to FIG. 5A below, this ring 402 keeps the cylinder 404 from being pulled out of the retaining sleeve that holds the retaining cylinder 404 within the mobile TV device.

FIG. 4B is a top-view diagram for the antenna connection mechanism for the collapsible antenna 104. As seen in FIG. 4B, the retaining cylinder 404 has a U-shaped section at its tip where the flat section 412 for the connector 308 is inserted. The pin 406 is then positioned through the U-shaped section of retaining cylinder 404 and the pin hole in connector 308. The connector 308 and, therefore, the entire antenna 104 can then rotate freely around the pin 406 thereby allowing for free motion in one plane. It is noted that the end of the section 412 that inserts into the U-shaped section of 404 can include beveled edges to provide a more natural stop for this rotation. A spring or other mechanism can also be provided to adjust this rotation so that the antenna 104 will tend to stay in place when rotated. As further described below with respect to the retaining sleeve in FIG. 5B, the retaining cylinder 404 is also allowed to rotate freely thereby allowing for the antenna to be freely positioned by the user in three dimensions.

FIG. 5A is an exploded view for a mobile television (TV) device having a collapsible antenna and an antenna connection mechanism. The mobile TV device has two clam shell outer pieces 504 and 512 that fit together to protect the internal components of the mobile TV device. These internal components can include a printed circuit board 510 including the operational circuitry for the mobile TV device. For example, the printed circuit board 510 can include an integrated circuit 508 that performs the reception, tuning and demodulation of the TV broadcast signals. A USB connector 204 and an auxiliary antenna input 110 can also be coupled to the printed circuit board 510. A space 506 for the antenna 104 can also be included within the claim shell outer pieces 504 and 512. This space 506 can be large enough to hold the antenna 104 and the retaining cylinder 404 when the antenna 104 is fully collapsed and pushed inside the mobile TV device.

The embodiment depicted also achieves considerable advantage by using a retaining sleeve 502 to receive the retaining cylinder 404 and the antenna 104. The retaining sleeve 505 is conductive and is soldered to a connection pad 503 that is coupled to the printed circuit board 510. The retaining cylinder 404 and the retaining sleeve 505 are configured such that the retaining cylinder 404 fits inside the internal diameter of the retaining sleeve 505. The ring 402, however, is larger than the internal diameter of the sleeve 505 and keeps the retaining cylinder 404 from being pulled out of the mobile TV device when the antenna 104 is extended by a user. Once the retaining cylinder 404 has been inserted through the sleeve 404, the pin 406 can be inserted through the U-shaped section of cylinder 404 and the pin hole in connector 308 thereby securing the antenna 104 in place. Once this is done, when the antenna 104 is pulled out, the ring 404 will engage the sleeve 505 and provide resistance so that the antenna 104 will telescope and expand as it is pulled. Conversely, when the antenna 104 is pushed in, the ring 404 can be configured to engage the edge of space 506 and provide resistance so that the antenna 104 will telescope and collapse as it is pushed into the mobile TV device. It is further noted that the cap 307 for the antenna can be configured to fit into a recess within the claim shell pieces 504 and 512 when the antenna is fully collapsed and pushed inside of the mobile TV device. This allows for a smooth outside finish to the mobile TV device when the antenna is fully collapsed.

FIG. 5B is a diagram for the internal connection sleeve 505 for the antenna connection mechanism. As depicted, the sleeve 505 is relatively cylindrical with two flattened edges and an internal open bore hole through its middle. The flattened edges for sleeve 505 allow for it to be more easily soldered to the connection pad 503 with the mobile TV device and reduce the effective height of the sleeve 505. As described above, this retaining sleeve 505 allows for the retaining cylinder to freely rotate within it thereby providing an additional degree of freedom for positioning the antenna. This additional degree of freedom is significant in allowing a user to freely position the antenna for optimal reception. The combination of the rotation of the antenna 104 allowed by sleeve 505 and the movement of the antenna 104 within a plane allowed by retaining cylinder 404 means that the user has complete three-degrees of freedom in positioning the antenna in order to obtain optimal reception.

Further modifications and alternative embodiments of the techniques described herein will be apparent to those skilled in the art in view of this description. It will be recognized, therefore, that the techniques described herein are not limited by these example arrangements. Accordingly, this description is to be construed as illustrative only and is for the purpose of teaching those skilled in the art the manner of carrying out the techniques described herein. It is to be understood that the forms of the techniques described herein shown and described are to be taken as the presently preferred embodiments. Various changes may be made in the implementations and architectures. For example, equivalent elements may be substituted for those illustrated and described herein and certain features of the techniques described herein may be utilized independently of the use of other features, all as would be apparent to one skilled in the art after having the benefit of this description of the techniques.

What is claimed is:

1. A mobile television device having a break-resistant antenna, comprising:
a device body;
television tuner and demodulator circuitry positioned within the device body to receive and demodulate television broadcast signals;
a telescoping antenna configured to be positioned within the device body when collapsed and configured to be external to the device body when extended, the telescoping antenna comprising:
a flexible base segment; and
a plurality of additional segments that are coupled to the base segment and are successively larger in diameter to provide telescoping; and
an antenna connection mechanism within the device body coupled to the telescoping antenna and to the television tuner and demodulator circuitry.

2. The mobile television device of claim 1, wherein the television tuner and demodulator circuitry is configured to operate with multiple different television broadcast standards.

3. The mobile television device of claim 1, wherein the connection mechanism is configured to allow the telescoping antenna at least to be moved freely within a plane.

4. The mobile television device of claim 1, wherein the connection mechanism is configured to allow the telescoping antenna at least to be freely rotated.

5. The mobile television device of claim 1, wherein the connection mechanism is configured to allow the telescoping antenna to be moved freely within a plane and to be freely rotated.

6. The mobile television device of claim 1, wherein the base segment for the telescoping antenna is coupled to a connector having a pin hole, wherein the connection mechanism is configured to receive the connector and to secure the connector using a pin inserted into the pin hole, and wherein the connector can freely rotate around the pin to allow the telescoping antenna to move freely within a plane.

7. The mobile television device of claim 1, wherein the connection mechanism comprises a conductive sleeve coupled to the device body and a retaining cylinder positioned within the conductive sleeve, wherein the retaining cylinder is also coupled to the telescoping antenna, and wherein the retaining cylinder can freely rotate within the sleeve to allow the telescoping antenna to be rotated freely.

8. The mobile television device of claim 7, wherein the conductive sleeve is cylindrical with at least one flattened edge.

9. The mobile television device of claim 7, wherein the base segment for the telescoping antenna is coupled to a connector having a pin hole, wherein the retaining cylinder comprises a U-shaped end configured to receive the connector and to secure the connector using a pin inserted into the pin hole, and wherein the connector can freely rotate around the pin to allow the telescoping antenna to move freely within a plane.

10. The mobile television device of claim 1, further comprising a bus interface coupled to the television tuner and demodulator circuitry.

11. The mobile television device of claim 9, wherein the bus interface comprises a universal serial bus (USB) interface.

12. The mobile television device of claim 1, further comprising an auxiliary antenna input within the device body and coupled to the television tuner and demodulator circuitry.

13. The mobile television device of claim 1, wherein the telescoping antenna has a cap configured to fit within a recess in the device body when the telescoping antenna is fully collapsed.

14. The mobile television device of claim 1, wherein the device body comprises a releasable cap configured to cover a bus interface connector.

15. The mobile television device of claim 1, wherein the telescoping antenna is configured to receive UHF frequencies when fully collapsed.

16. A method for receiving television broadcasts with a break-resistant antenna, comprising:
providing a device body coupled to a telescoping antenna;
adjusting the telescoping antenna to receive television broadcasts, the telescoping antenna configured to be positioned within the device body when collapsed and configured to be external to the device body when extended, the telescoping antenna further comprising:
a flexible base segment; and
a plurality additional segments that are coupled to the base segment and are successively larger in diameter to provide telescoping;
receiving and demodulating a television broadcast using the telescoping antenna; and
communicating demodulated television broadcast information to an external device.

17. The method of claim 16, wherein the receiving step can be performed with multiple different broadcast standards.

18. The method of claim 16, wherein the adjusting step further comprises moving the telescoping antenna freely within a plane to position it.

19. The method of claim 16, wherein the adjusting step further comprises freely rotating the telescoping antenna to position it.

20. The method of claim 16, wherein the adjusting step further comprises freely rotating the telescoping antenna and moving the telescoping antenna freely within a plane to position it.
